(19) United States
(12) Patent Application Publication
(10) Pub. No.: US 2026/0140248 A1
(43) Pub. Date: May 21, 2026

(54) INDOOR POSITIONING SYSTEM AND METHOD OF CONTROLLING THE SAME

(71) Applicant: IDCITI.COM, Inchon (KR)

(72) Inventors: Jihoon RYOO, Incheon (KR); Azimbek KHUDOYBERDIEV, Incheon (KR); In-sun KIM, Incheon (KR)

(21) Appl. No.: 19/392,877

(22) Filed: Nov. 18, 2025

(30) Foreign Application Priority Data
Nov. 19, 2024 (KR) 10-2024-0165546

(51) Int. Cl. G01S 13/46; G01S 13/58; G01S 13/931; G06V 20/54; G06V 20/62; H04J 13/16

(52) U.S. Cl. CPC G01S 13/46; G01S 13/58; G06V 20/54; G06V 20/625; H04J 13/16; G01S 2013/9323

(57) ABSTRACT

An indoor positioning system includes a camera, a position detection sensor, a first communication module, memory storing at least one instruction, and at least one processor. The at least one processor is configured to, by executing the at least one instruction, generate positional information by recognizing a position of a vehicle moving on a road based on a position detection signal of the position detection sensor, and recognize vehicle license plate information and the position of the vehicle moving on the road based on an input image captured by the camera. The at least one processor is further configured to encode the positional information in a code-division multiple access (CDMA) method using a spreading code generated from the vehicle license plate information, and output the encoded positional information as a wireless signal through the first communication module.

### CROSS-REFERENCE TO RELATED APPLICATION

This application is based on and claims priority under 35 U.S.C. § 119 to Korean Patent Application No. 10-2024-0165546, filed on Nov. 19, 2024, in the Korean Intellectual Property Office, the disclosure of which is incorporated by reference herein in its entirety.

### BACKGROUND

### Technical Field

Embodiments relate to an indoor positioning system and a method of controlling the indoor positioning system.

### Description of Related Technology

To determine an object's position, a global navigation satellite system (GNSS), which determines positions based on a satellite signal, is widely used. The GNSS calculates a receiver's position based on information received from satellites. GNSSs include, for example, the global positioning system (GPS) of the USA, GLONASS of Russia, the Galileo system of the European Union (EU), Beidou of China, the Quasi-Zenith satellite system (QZSS) of Japan, and the Indian regional navigation satellite system (IRNSS) of India.

### SUMMARY

One aspect is an indoor positioning system that may include a camera, a position detection sensor, a first communication module, memory storing at least one instruction, and at least one processor. The at least one processor is configured to, by executing the at least one instruction, may generate, based on a position detection signal of the position detection sensor, positional information by recognizing a position of a vehicle moving on a road. Also, the at least one processor may recognize vehicle license plate information and the position of the vehicle moving on the road based on an input image captured by the camera. Also, the at least one processor may encode the positional information in a code-division multiple access (CDMA) method using a spreading code generated from the vehicle license plate information Also, the at least one processor may output the encoded positional information as a wireless signal through the first communication module.

Also, according to an embodiment, the indoor positioning system may include a plurality of detection devices arranged at different positions in an indoor space, a server configured to communicate with the plurality of detection devices, and a wireless output device positioned within the indoor space and configured to communicate with the server. Each of the plurality of detection devices may include the camera, the position detection sensor, and a second communication module communicating with the server The server may include the memory and the at least one processor and further include a third communication module configured to communicate with the plurality of detection devices and the wireless output device. The wireless output device may include the first communication module communicating with the server and outputting the wireless signal.

Also, according to an embodiment, the plurality of detection devices may be each configured to generate the positional information based on the position detection signal, generate the vehicle license plate information based on the input image, and transmit the positional information and the vehicle license plate information to the server through the second communication module.

Also, according to an embodiment, the server may be further configured to receive the vehicle license plate information and the positional information from each of the plurality of detection devices through the third communication module, encode the positional information in the CDMA method using the spreading code generated from the vehicle license plate information, and transmit an encoded code signal to the wireless output device.

Also, according to an embodiment, the wireless output device may be configured to broadcast the wireless signal through the first communication module.

Also, according to an embodiment, the position detection sensor may include one of a radio detection and ranging (RADAR) sensor and a light detection and ranging (LIDAR) sensor, and the at least one processor may be further configured to generate speed information of a vehicle of which position is recognized based on the position detection signal by executing the at least one instruction, and output the speed information as the wireless signal.

Also, according to an embodiment, the at least one processor may be further configured to match the positional information generated from the position detection signal to the vehicle license plate information based on the positional information generated from the position detection signal and the position of the vehicle recognized from the input image, and encode the positional information in the CDMA method using the spreading code generated from the matched vehicle license plate information.

Also, according to an embodiment, the at least one processor may be further configured to, by executing the at least one instruction, generate encoded code signals, which are encoded in the CDMA method, for pieces of positional information of a plurality of vehicles, generate a composite signal by adding the code signals for the pieces of positional information of the plurality of vehicles, and output the composite signal as the wireless signal.

Also, according to an embodiment, the composite signal may be received by a client device arranged inside the vehicle, and be decoded using a despreading code generated from the vehicle license plate information stored in the client device.

Also, according to an embodiment, the at least one processor may be further configured to, by executing the at least one instruction, hash the vehicle license plate information, convert the hashed vehicle license plate information into orthogonal codes that are orthogonal to each other, and encode the positional information in the CDMA method using the orthogonal codes as spreading codes.

Also, according to an embodiment, an operation of outputting the encoded positional information as the wireless signal may include converting the encoded positional information into a plurality of data chunks, generating a bitstream for each frame from the plurality of data chunks, converting the bitstream for each frame into a quadrature phase shift keying (QPSK) symbol, up-sampling the QPSK symbol using a raised cosine (RC) transmission filter, and outputting the up-sampled QPSK symbol as the wireless signal through an additive white Gaussian noise (AWGN) channel.

Another aspect is a method of controlling an indoor positioning system that may include generating, based on a position detection signal of the position detection sensor, positional information by recognizing a position of a vehicle moving on a road, recognizing vehicle license plate information and the position of the vehicle moving on the road based on an input image captured by a camera, encoding the positional information in a code-division multiple access (CDMA) method using a spreading code generated from the vehicle license plate information, and outputting the encoded positional information as a wireless signal.

Additional aspects will be set forth in part in the description which follows and, in part, will be apparent from the description, or may be learned by practice of the presented embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings.

The present invention may be readily understood by combining detailed descriptions below with the accompanying drawings, in which reference numerals denote structural elements.

FIG. 1 illustrates a structure of an indoor positioning system according to an embodiment.

FIG. 2 is a block diagram illustrating a structure of an indoor positioning system according to an embodiment.

FIG. 3 is a flowchart illustrating a method of controlling an indoor positioning system according to an embodiment.

FIG. 4 is a diagram illustrating a structure of an indoor positioning system according to an embodiment.

FIG. 5 is a diagram illustrating a process of encoding and decoding positional information, according to an embodiment.

FIG. 6 is a flowchart illustrating a method of controlling an indoor positioning system, according to an embodiment.

FIG. 7 illustrates a process of generating and transmitting a wireless signal, according to an embodiment.

FIG. 8 is a diagram illustrating a process of receiving and decoding a wireless signal by a client device, according to an embodiment.

FIG. 9 illustrates a process of outputting wireless signals by a plurality of wireless output devices, according to one embodiment.

FIG. 10 is a diagram illustrating a data structure of a wireless signal, according to an embodiment.

### DETAILED DESCRIPTION

Because the GNSS uses information received from satellites, it is difficult to determine a receiver's position in a GNSS shadow region in which line-of-sight (LOS) communication with the satellite is impeded, such as underground facilities. Accordingly, it is difficult to provide accurate positional information when a user wants to provide positional information by using the GNSS indoors. For example, in a system that requires positional information indoors, underground, or within tunnels, such as a bus arrival time notification service or a navigation system in an underground facility, the quality of public services useful to citizens may degrade due to limitations of the GNSS. When a bus is located in an underground transfer center or long tunnel, tracking a position of the bus may not be possible due to unavailable GNSS reception, and accordingly, it is difficult to determine a position of the bus and expected arrival time of the bus to be provided by an estimated arrival time service.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The specification clarifies the scope of claims of the present disclosure, describes the principles of embodiments, and discloses the embodiments to enable those skilled in the art to practice the embodiments. The embodiments may be implemented in various forms.

Various embodiments and terminology used in the present description are not intended to limit the technical features described herein to specific examples, and should be understood to include various modifications, equivalents, or alternatives of the embodiments.

In connection with the description of the drawings, similar reference numerals may be used to refer to similar or related components.

The singular form of a noun corresponding to an item may include one or more of the items, unless the context clearly dictates otherwise.

Terms, such as “first”, “second”, or “first” or “second” may be used merely to distinguish one component from another component and do not limit the components in any other respect (for example, importance or order).

When a component (for example, the first component) is described to be “coupled” or “connected” to another component (for example, the second component) together, with or without the terms “functionally” or “communicatively”, it means that the component may be connected to another component directly (for example, wired), wirelessly, or through a third component.

Terms, such as “comprise/include” or “have” are intended to specify the presence of a feature, number, step, operation, component, element, or a combination thereof described herein, but do not preclude the presence or addition of one or more another feature, number, step, operation, component, element, or a combination thereof.

When a component is described to be “connected”, “coupled”, “supported”, or “in contact with” another component, this includes not only a case where the component is directly connected, coupled, supported, or in contact with another component, but also a case where the component is indirectly connected, coupled, supported, or in contact with another component through the third component.

The same reference numerals refer to the same components throughout the specification. The specification does not describe all elements of the embodiments, and any general content or overlapping content between embodiments in the technical field to which the embodiments belong is omitted. The term “part or portion” used in the specification may be implemented in software or hardware, and depending on embodiments, a plurality of “portions, units, or elements” may be implemented as a single portion (a single unit or a single element), or a single “portion” may include a plurality of portions. Hereinafter, embodiments and operating principles of the embodiments will be described with reference to the attached drawings.

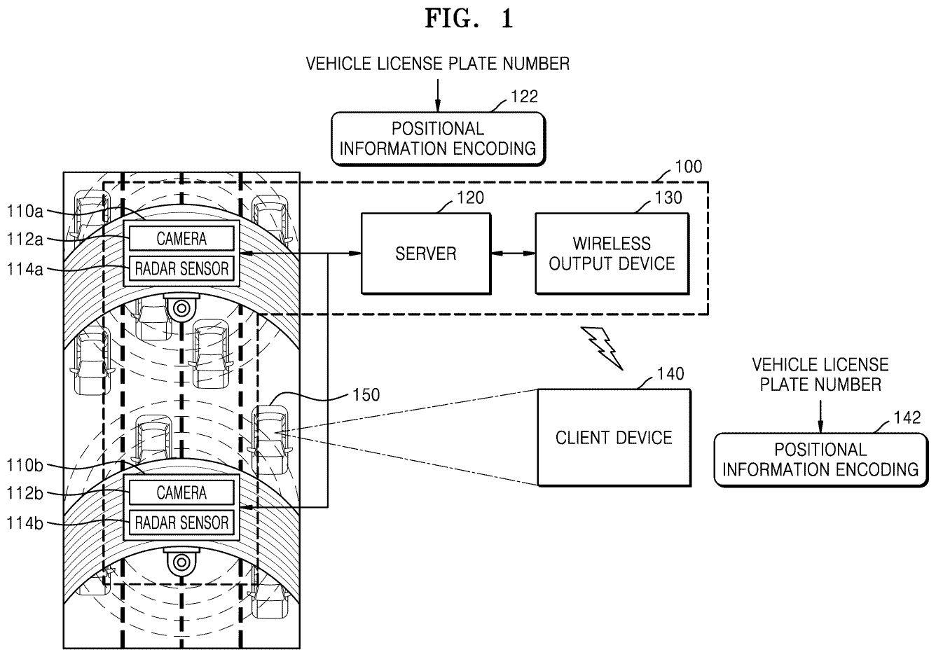

FIG. 1 illustrates a structure of an indoor positioning system according to an embodiment.

According to an embodiment, an indoor positioning system 100 may recognize a position of a vehicle 150 moving on a road in an indoor space and output positional information of the vehicle 150.

The indoor space may correspond to a GNSS shadow region to which a satellite signal is not transmitted due to an obstacle, such as concrete or rebars. The indoor space may correspond to, for example, a tunnel, an underground parking lot, the inside of a building, an underground space, or so on. The disclosure focuses on an embodiment in which the indoor space corresponds to a tunnel. However, the embodiments are not limited to this case only, and the indoor positioning system 100 according to the embodiments may be applied to other various indoor spaces, such as an underground parking lot.

The indoor positioning system 100 may include one or more detection devices 110a and 110b, a server 120, and a wireless output device 130. The detection devices 110a and 110b may include cameras 112a and 112b and position detection sensors 114a and 114b. In the disclosure, the detection devices 110a and 110b may be collectively denoted by reference numeral 110, the cameras 112a and 112b may be collectively denoted by reference numeral 112, and the position detection sensors 114a and 114b may be collectively denoted by reference numeral 114.

The detection devices 110 may be located at multiple positions inside a tunnel. For example, the detection devices 10 may be arranged at intervals of 1 km along a road in the tunnel. The detection devices 110 may communicate with a server 120. The detection devices 110 may communicate with the server 120 through wired or wireless communication.

The detection devices 110 may respectively include the cameras 112 and the position detection sensors 114. The cameras 112 may each capture an image of the vehicle 150 moving on a road and generate an input image. The detection devices 110 may each obtain vehicle license plate information of the vehicle 150 moving on the road based on the input image. Also, the detection devices 110 may each detect positional information of the vehicle 150 in response to a position detection signal of each of the position detection sensors 114. The detection devices 110 may each transmit the vehicle license plate information and positional information to the server 120.

The server 120 may encode the vehicle license plate information and positional information received from at least one of the detection devices 110. In operation 122, the server 120 may encode the positional information based on the vehicle license plate information through a code-division multiple access (CDMA) method. Also, the server 120 may generate a composite signal by synthesizing pieces of the encoded positional information of the vehicles 150. The server 120 may transmit the composite signal to the wireless output device 130.

A plurality of wireless output devices 130 may be installed at a plurality of positions inside a tunnel. The wireless output device 130 may receive the composite signal from the server 120 and output the composite signal as a wireless signal. The wireless output device 130 may broadcast the wireless signal through Wi-Fi communication.

A client device 140 may correspond to an electronic device built in the vehicle 150 or an electronic device (for example, a cellular phone, a wearable device, a tablet personal computer (PC), a laptop PC, or so on) used by a passenger in the vehicle 150. The client device 140 receives the wireless signal output from the wireless output device 130. The client device 140 may include a program or application for decoding the positional information encoded by the server 120. The client device 140 may store in advance the vehicle license plate information of the vehicle 150. In operation 142, the client device 140 may obtain positional information by decoding information included in the wireless signal received from the wireless output device 130 based on vehicle license plate information of a corresponding vehicle 150.

According to an embodiment, the server 120 may provide accurate positional information of the vehicle 150 located in a GNSS shadow region by encoding positional information of the vehicle 150 based on vehicle license plate information, and decoding, by the client device 140, the positional information included in a wireless signal based on the vehicle license plate information.

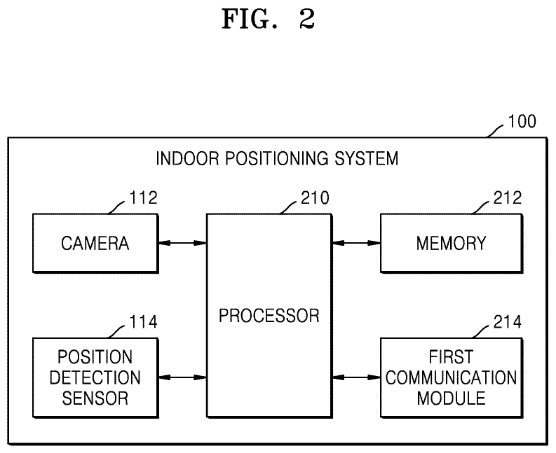

FIG. 2 is a block diagram illustrating a structure of an indoor positioning system according to an embodiment.

According to an embodiment, an indoor positioning system 100 may include a camera 112, a position detection sensor 114, a processor 210, memory 212, and a first communication module 214.

Although FIG. 1 illustrates an embodiment in which the indoor positioning system 100 includes the detection devices 110, the server 120, and the wireless output device 130, the indoor positioning system 100 may have various system configurations. For example, the detection devices 110 and the server 120 may be implemented as a single device. In another example, the server 120 and the wireless output device 130 may be implemented as a single device. In another example, the detection devices 110, the server 120, and the wireless output device 130 may be implemented as a single device.

The camera 112 captures an image of a license plate of the vehicle 150 moving on a road inside a tunnel. The camera 112 may be arranged to capture an image of a license plate from the front or rear of the vehicle 150. The camera 112 may include a lens and an image sensor. The camera 112 may capture images at a preset frame rate and generate an input image. The input image may correspond to a still image or a moving image.

The position detection sensor 114 may be arranged to detect a vehicle moving on a road. The position detection sensor 114 may include one of, for example, a radio detection and ranging (radar) sensor and a light detection and ranging (lidar) sensor.

The radar sensor may generate electromagnetic waves, output the electromagnetic waves toward an object, and detect a distance to the object and a direction of the object based on electromagnetic waves reflected from the object. The radar sensor may be a time of flight (ToF) sensor. The radar sensor may detect an object at a long distance (approximately 2 km).

The processor 210 may control all operations of the indoor positioning system 100. The processor 210 may include one or more processors. The processor 210 may perform a preset operation by executing instructions or commands stored in the memory 212. Also, the processor 210 may control operations of components included in the indoor positioning system 100. The processor 210 may include a central processing unit (CPU), a microprocessor, a graphics processing unit (GPU), or a neural processing unit (NPU).

The memory 212 stores various types of information, data, commands, programs, and so on required to operate the indoor positioning system 100.

The memory 212 may include at least one of a volatile memory and a non-volatile memory, or a combination thereof.

The memory 212 may include at least one type of storage medium among a flash memory type, a hard disk type, a multimedia card micro type, a card type memory (for example, a secure digital (SD) card or an extreme digital (XD) card), random access memory (RAM), static random access memory (SRAM), read-only memory (ROM), electrically erasable programmable read-only memory (EEPROM), programmable read-only memory (PROM), a magnetic memory, a magnetic disk, and an optical disk. Also, the memory 212 may correspond to a web storage or cloud server that performs a storage function on the Internet.

The first communication module 214 may communicate with at least one external device in a wired or wireless manner. The first communication module 214 may include a wireless communication module (for example, a cellular communication module, a near field wireless communication module, or a global navigation satellite system (GNSS) communication module) or a wired communication module (for example, a local area network (LAN) communication module or a power line communication module).

Also, the first communication module 214 may perform near field communication, and may use, for example, Bluetooth, Bluetooth low energy (BLE), near field communication, a wave local area network (WLAN) (Wi-Fi), Zigbee, infrared (infrared data association (IrDA)) communication, Wi-Fi direct (WFD), ultrawideband (UWB), Ant+ communication, and so on.

Also, for example, the first communication module 214 may perform long distance communication, and may communicate with external devices through, for example, a legacy cellular network, a fourth generation (4G) network, a fifth generation (5G) network, a next-generation communication network, the Internet, or a computer network (for example, a LAN or WAN).

For example, the first communication module 214 may use mobile communication and transmit and receive wireless signals to and from at least one of a base station, an external terminal, and a server through a mobile communication network.

The first communication module 214 may use a universal software radio peripheral (USRP).

Also, the first communication module 214 may correspond to an access point (AP) device using Wi-Fi communication.

The processor 210 recognizes vehicle license plate information of the vehicle 150 from an input image captured by the camera 112. The processor 210 may use an automatic number plate recognition (ANPR) algorithm. The processor 210 may recognize the vehicle 150 from the input image and perform object tracking on the vehicle 150. Also, the processor 210 may recognize a position of the vehicle 150 from the input image.

Also, the processor 210 may recognize a position of the vehicle 150 moving on a road based on a position detection signal of the position detection sensor 114 and generate positional information. The positional information may be defined as coordinate information in a preset coordinate system. For example, the coordinate information may be defined as x, y, and z coordinates.

The processor 210 may match the positional information generated from the position detection signal to the vehicle license plate information recognized from the input image based on the position recognized from the input image and the positional information generated from the position detection signal. Also, the processor 210 may track the vehicle 150 recognized by the position detection sensor 114 and track the positional information corresponding to the vehicle license plate information.

The processor 210 may encode the positional information in a CDMA method. In this case, the processor 210 may generate a spreading code from the vehicle license plate information and perform CDMD encoding using the spreading code. The CDMA encoding multiplies data by a spreading code during an encoding process to spread the spectrum. The spreading code may correspond to an orthogonal code. The processor 210 may generate an orthogonal code from the vehicle license plate information and encode the positional information in a CDMA method using the generated orthogonal code as a spreading code. In this case, the processor 210 may hash the vehicle license plate information with a hash function, convert the vehicle license plate information into an orthogonal code, and use the converted vehicle license plate information as a spreading code. The processor 210 may generate a code signal by CDMA-encoding the positional information. Also, the processor may generate a composite signal by synthesizing a plurality of code signals.

The processor 210 may output the composite signal generated from the plurality of code signals as a wireless signal through the first communication module 214.

The first communication module 214 may broadcast a wireless signal. The first communication module 214 may broadcast a wireless signal without establishing a communication channel with the client device 140. The first communication module 214 may broadcast a wireless signal through Wi-Fi communication. The client device 140 around the first communication module 214 may receive a wireless signal broadcasted from the first communication module 214. The client device 140 may receive the broadcasted wireless signal even without establishing a channel with the indoor positioning system 100 in advance. The client device 140 may receive a wireless signal and decode the data included in the wireless signal to obtain positional information. The client device 140 may receive the vehicle license plate information in advance and generate a despreading code from the vehicle license plate information. The client device 140 may decode the received composite signal using the generated despreading code and obtain positional information.

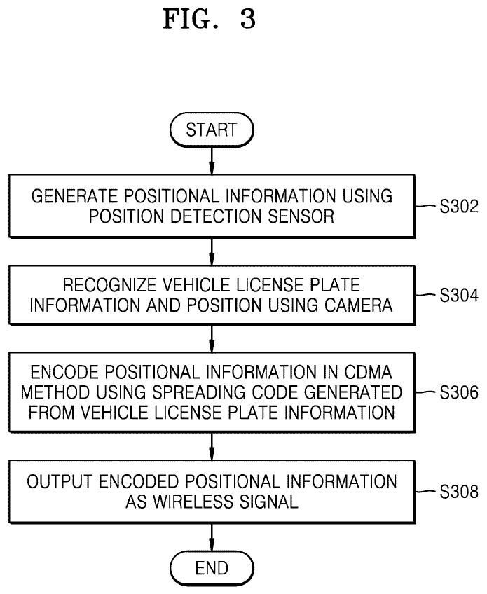

FIG. 3 is a flowchart illustrating a method of controlling an indoor positioning system, according to an embodiment.

The method of controlling an indoor positioning system, according to an embodiment, may be performed by the indoor positioning system 100 according to an embodiment. However, the method of controlling an indoor positioning system, according to an embodiment, is not limited to the embodiment performed by the indoor positioning system 100 according to an embodiment, and may be performed by various systems including a camera, a lidar sensor, a processor, and a communication module.

Referring to FIG. 3, in operation S302, the indoor positioning system 100 may generate positional information of the vehicle 150 in response to a position detection signal of the position detection sensor 114. The indoor positioning system 100 may recognize the vehicle 150 in response to the position detection signal and generate the positional information of the vehicle 150. According to an embodiment, the indoor positioning system 100 may generate speed information of the vehicle 150 based on the positional information of the vehicle 150 over time.

In operation S304, the indoor positioning system 100 recognizes vehicle license plate information from an input image captured by the camera 112. The indoor positioning system 100 may recognize the vehicle license plate information from the input image using a license plate recognition algorithm, a character recognition algorithm, or so on. Also, the indoor positioning system 100 recognizes a position from the input image. The position recognized from the input image may be an approximate position of the vehicle 150, which may be less accurate than the positional information detected from the position detection signal.

Next, in operation S306, the indoor positioning system 100 may encode the positional information in a CDMA method using a spreading code generated from the vehicle license plate information. The indoor positioning system 100 may process the vehicle license plate information using a hash function and convert the vehicle license plate information into an orthogonal code. The indoor positioning system 100 may define the vehicle license plate information converted into the orthogonal code as a spreading code.

The indoor positioning system 100 may match the positional information to the vehicle license plate information based on a position recognized from the input image and the positional information generated from the position detection signal.

Next, the indoor positioning system 100 may output the encoded positional information as a wireless signal in operation S308. The indoor positioning system 100 may generate a composite signal by synthesizing a plurality of code signals generated by CDMA-encoding a plurality of pieces of positional information of a plurality of vehicles. The indoor positioning system 100 may convert the composite signal into a wireless signal and broadcast and output the wireless signal.

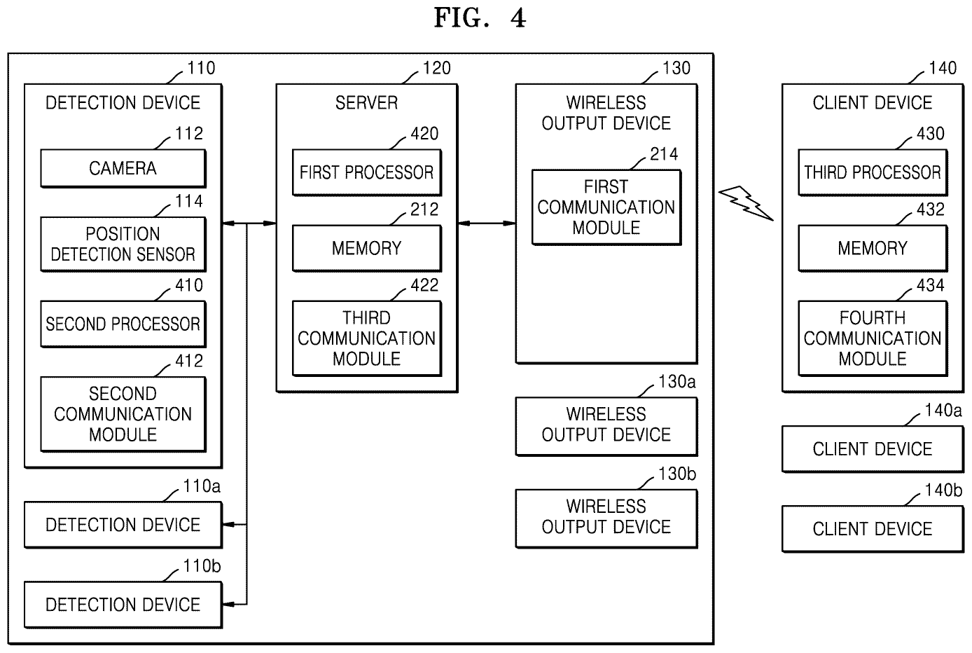

FIG. 4 is a diagram illustrating a structure of an indoor positioning system according to an embodiment.

According to an embodiment, an indoor positioning system 100 may include detection devices 100, 110a, and 110b, a server 120, and wireless output devices 130, 130a, and 130b. The indoor positioning system 100 may include a plurality of detection devices 110, 110a, and 110b. In the disclosure, the plurality of detection devices 110, 110a and 110b may be collectively referred to as detection devices 110. Also, the indoor positioning system 100 may include a plurality of wireless output devices 130, 130a, and 130b. In the disclosure, the plurality of wireless output devices 130, 130a, and 130b may be collectively referred to as wireless output devices 130.

The detection devices 110 may be arranged at different positions at preset intervals inside a tunnel. For example, the detection devices 110 may be arranged on a ceiling of the tunnel at intervals of about 1 km to about 2 km. The detection devices 110 may each include a camera 112, a position detection sensor 114, a second processor 410, and a second communication module 412.

The second processor 410 of each of the detection devices 110 may recognize the vehicle 150 and vehicle license plate information from an input image generated by the camera 112. Also, the second processor 410 may recognize a position of the vehicle 150 from the input image.

Also, the second processor 410 may recognize the vehicle 150 and positional information of the vehicle 150 from a position detection signal generated by the position detection sensor 114. The second processor 410 may generate positional information by defining coordinate information of the vehicle 150 in a preset coordinate system. For example, the coordinate information of the vehicle 150 may be defined as x, y, and z coordinates. Also, the second processor 410 may generate speed information of the vehicle 150 based on positional information over time.

The second processor 410 may match the vehicle license plate information to the positional information generated from the position detection signal. The second processor 410 may transmit the vehicle license plate information and positional information to the server 120 through the second communication module 412. The second communication module 412 may transmit the vehicle license plate information and positional information to the server 120 through wired or wireless transmission. The second processor 410 may transmit the vehicle license plate information and positional information along with detection time information. Also, according to an embodiment, the detection devices 110 may each transmit the input image to the server 120.

The server 120 may receive the vehicle license plate information, the positional information, and the detection time information from each of the detection devices 110 through a third communication module 422. Also, according to an embodiment, the server 120 may receive speed information from the detection devices 110. A first processor 420 of the server 120 may encode the positional information of each vehicle 150 in a CDMA method based on the vehicle license plate information. The first processor 420 may generate a spreading code based on the vehicle license plate information and encode the positional information using the generated spreading code. The first processor 420 may generate a code signal by encoding the positional information in a CDMA method.

The first processor 420 may generate a composite signal by synthesizing a plurality of code signals. For example, the first processor 420 may generate the composite signal by synthesizing four code signals. The first processor 420 may transmit the composite signal to the wireless output device 130.

The plurality of wireless output devices 130, 130a, and 130b may be arranged at different positions inside a tunnel. The wireless output device 130 may include a first communication module 214. The wireless output device 130 wirelessly outputs the composite signal through the first communication module 214. The first communication module 214 may broadcast the composite signal through Wi-Fi communication. The server 120 may periodically encode positional information, generate a composite signal, and output the composite signal to the wireless output device 130. The wireless output device 130 may convert the composite signal into a wireless signal and output the wireless signal when receiving the composite signal.

A client device 140 may receive the wireless signal output from the wireless output device 130.

The client device 140 may include a third processor 430, a memory 432, and a fourth communication module 434.

The memory 432 may store vehicle license plate information corresponding to the client device 140.

The third processor 430 may execute a preset program or application stored in the memory 432. The third processor 430 may execute the program or application and decode the received wireless signal based on the vehicle license plate information.

The third processor 430 may generate a spreading code from the vehicle license plate information. The third processor 430 may generate a spreading code by processing the vehicle license plate information using a hash function and converting a value processed by the hash function into an orthogonal code. The third processor 430 may cause a CDMA decoder to decode a wireless signal using a spreading code. In this case, when the positional information included in the wireless signal corresponds to the vehicle license plate information stored in the client device 140, the wireless signal may be decoded into a valid value. When the positional information included in the wireless signal does not correspond to the vehicle license plate information stored in the client device 140, the positional information may not be decoded into a valid value. Therefore, the client device 140 may obtain positional information of the client device 140 by obtaining positional information decoded into a valid value based on the stored vehicle license plate information.

A plurality of client devices 140, 140a, and 140b may store different types of vehicle license plate information. Therefore, the plurality of client devices 140, 140a, and 140 may each obtain positional information by decoding only a wireless signal including positional information corresponding to the vehicle license plate information stored in a corresponding device into a valid value.

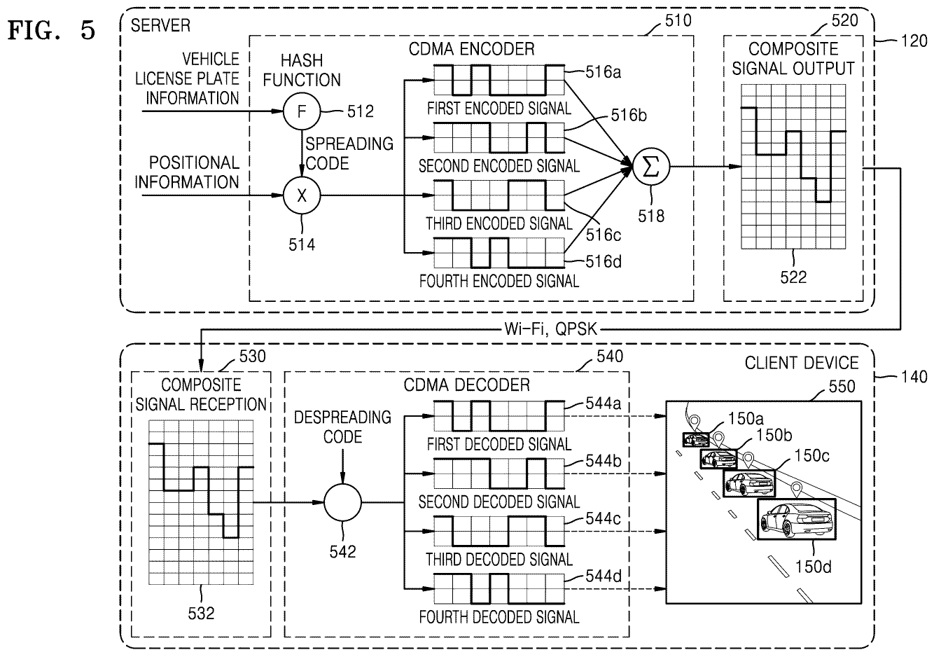

FIG. 5 is a diagram illustrating a process of encoding and decoding positional information, according to an embodiment.

According to an embodiment, a server 120 may encode positional information in a CDMA method using a CDMA encoder 510 to generate a code signal. The CDMA encoder 510 may be operated by the first processor 420.

The CDMA encoder 510 may receive vehicle license plate information and positional information. The vehicle license plate information is hashed using a hash function 512. Also, the hashed vehicle license plate information may be converted into an orthogonal code. The orthogonal code may be defined as a spreading code.

The CDMA encoder 510 may generate first to fourth code signals 516a, 516b, 516c, and 516d by synthesizing the spreading code generated based on the vehicle license plate information and the positional information by a combiner 514.

The combiner 514 may encode positional information using an orthogonal code as a spreading code according to a CDMA standard.

The CDMA encoder 510 may generate the first to fourth code signals 516a, 516b, 516c, and 516d based on the positional information and the vehicle license plate information matching each other. For example, the CDMA encoder 510 may generate the first code signal 516a by encoding positional information of a first vehicle 150a in a CDMA method using a spreading code generated from the vehicle license plate information of the first vehicle 150a. Also, the CDMA encoder 510 may generate the second code signal 516b by encoding positional information of a second vehicle 150b in a CDMA method using a spreading code generated from vehicle license plate information of the second vehicle 150b. Also, the CDMA encoder 510 may generate the third code signal 516c by encoding positional information of a third vehicle 150c in a CDMA method using a spreading code generated from the vehicle license plate information of the third vehicle 150c. Also, the CDMA encoder 510 may generate the fourth code signal 516d by encoding positional information of a fourth vehicle 150d in a CDMA method using a spreading code generated from the vehicle license plate information of the third vehicle 150d.

Positional information of each vehicle 150 may be continuously generated over time. Positional information may be generated periodically and encoded by the CDMA encoder 510. For example, the positional information may be generated at intervals of one second, and the CDMA encoder 510 may generate the first to fourth code signals 516a, 516b, 516c, and 516d on the positional information at intervals of one second.

The CDMA encoder 510 may generate a composite signal 522 by synthesizing the first to fourth code signals 516a, 516b, 516c, and 516d by using a combiner 518. The combiner 518 may synthesize a preset number of encoded signals among the first to fourth code signals 516a, 516b, 516c, and 516d. For example, the combiner 518 may generate the composite signal 522 by synthesizing the four code signals 516a, 516b, 516c, and 516d. The server 120 may output the composite signal 522 through the third communication module 422 (see FIG. 4) in operation 520.

According to an embodiment, the server 120 may generate a composite signal corresponding to a quadrature phase shift keying (QPSK) symbol. The QPSK symbol is transmitted after four types of digital symbols are synthesized by shifting a phase by 90°. The server 120 may convert the composite signal into a QPSK symbol and then convert the QPSK symbol into a wireless signal.

The server 120 may output the wireless signal through the wireless output device 130 (see FIG. 4). The wireless output device 130 may broadcast the wireless signal through a Wi-Fi network.

The client device 140 may receive a broadcasted Wi-Fi signal. The client device 140 may receive a composite signal 532 in operation 530.

The client device 140 may include a CDMA decoder 540. The CDMA decoder 540 may be operated by the third processor 430 (see FIG. 4) of the client device 140.

In operation 542, the client device 140 may decode a code signal obtained from a wireless signal by using the CDMA decoder 540 based on a despreading code. The client device 140 may generate the despreading code based on vehicle license plate information stored in a corresponding device. The client device 140 may hash the stored vehicle license plate information using a hash function, convert the vehicle license plate information into an orthogonal code, and define the orthogonal code as a despreading code.

The CDMA decoder 540 may generate first to fourth decoded signals 544a, 544b, 544c, and 544d by decoding a code signal obtained from a received wireless signal using the despreading code. The first to fourth decoded signals 544a, 544b, 544c, and 544d may have valid values when including positional information corresponding to the vehicle license plate information stored in the client device 140. When the positional information of the first to fourth decoded signals 544a, 544b, 544c, and 544d does not correspond to the vehicle license plate information stored in the client device 140, the first to fourth decoded signals 544a, 544b, 544c, and 544d may have invalid values.

Following descriptions are made by using an example of an image 550 captured from a vehicle moving in a tunnel illustrated in FIG. 5. It is assumed that, among the first to fourth code signals 516a, 516b, 516c, and 516d included in the composite signal 532, the first encoded signal 516a corresponds to the first vehicle 150a. When the CDMA decoder 540 included in the first vehicle 150a decodes the composite signal 532 using a despreading code generated from vehicle license plate information of the first vehicle 150a, the first decoded signal 544a obtained by decoding the first code signal 516a may have a valid value. Also, when the CDMA decoder 540 included in the first vehicle 150a decodes the composite signal 532 using the despreading code generated from the vehicle license plate information of the first vehicle 150a, the second decoded signal 544b, the third decoded signal 544c, and the fourth decoded signal 544d, which are obtained respectively by decoding the second code signal 516b, the third code signal 516c, and the fourth code signal 516d, may each have an invalid value.

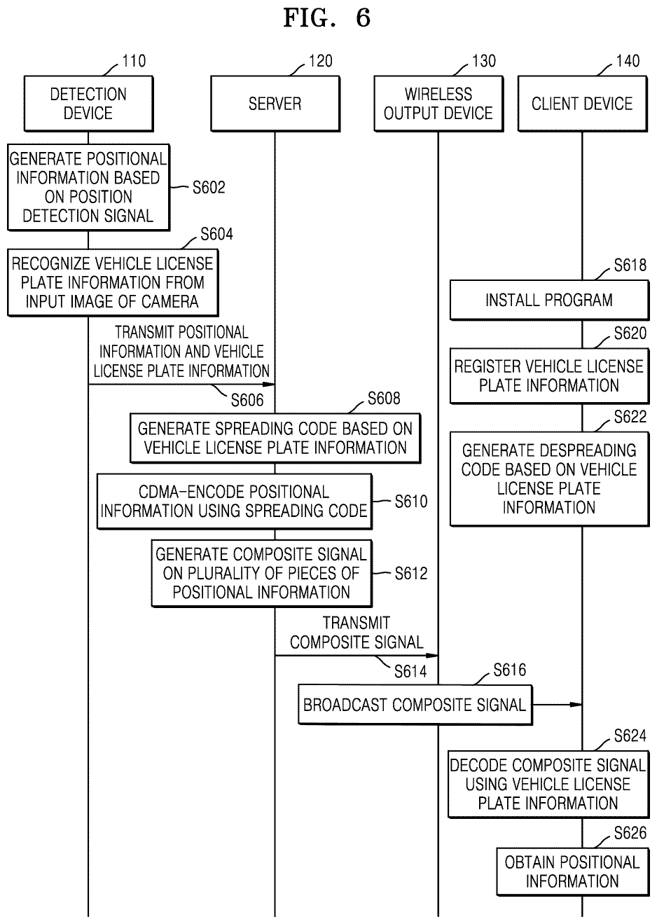

FIG. 6 is a flowchart illustrating a method of controlling an indoor positioning system, according to an embodiment.

FIG. 6 is a flowchart illustrating operations of the detection device 110, the server 120, the wireless output device 130, and the client device 140 of the indoor positioning system 100.

In operation S602, the detection device 110 generates positional information based on a position detection signal generated by the position detection sensor 114. The detection device 110 may generate positional information of the vehicle 150 while performing object tracking for each vehicle 150 based on the position detection signal.

Also, in operation S604, the detection device 110 may recognize the vehicle 150 and the vehicle license plate information of the vehicle 150 from an input image captured by the camera 110. The detection device 110 may generate the vehicle license plate information using an ANRP algorithm. Also, the detection device 110 may recognize a position of the vehicle 150 based on an input image.

The detection device 110 may match the positional information generated from the position detection signal to the vehicle license plate information. In operation S606, the detection device 110 may transmit the positional information and vehicle license plate information of the vehicle 150 to the server 120.

In operation S608, the server 120 generates a spreading code based on the vehicle license plate information. The server 120 generates an orthogonal code from the vehicle license plate information. The server 120 may use the generated orthogonal code as a spreading code for CDMA encoding.

In operation S610, the server 120 may cause a CDMA encoder to encode the positional information using the spreading code generated from the vehicle license plate information. The server 120 may generate a code signal encoded in a CDMA method.

Next, in operation S612, the server 120 may generate a composite signal by synthesizing a plurality of code signals. The plurality of code signals may respectively correspond to pieces of positional information of different vehicles 150. According to an embodiment, the server 120 may generate a composite signal by QPSK-modulating four code signals by using a QPSK modulator. Also, the server 120 may generate a composite signal by modulating the code signal with at least one of, for example, bi-phase shift keying (BPSK), quadrature amplitude modulation (QAM), or orthogonal frequency division multiple access (OFDMA).

Next, in operation S614, the server 120 may transmit the composite signal to the wireless output device 130.

The wireless output device 130 may broadcast the composite signal in operation S616. According to an embodiment, the wireless output device 130 may broadcast the composite signal using a user datagram protocol (UDP). Also, the wireless output device 130 may transmit the composite signal through Wi-Fi communication.

The client device 140 may install a preset program or application in operation S618. The program or application executed by the client device 140 is referred to as a client program.

The client program may correspond to a program that receives and uses positional information. The client program may obtain positional information by receiving a GNSS satellite signal or by receiving a broadcast signal according to an embodiment. The client program may obtain positional information by receiving a GNSS satellite signal outdoors and by receiving a Wi-Fi broadcast signal in a GNSS shadow region.

When a certain region is determined to be a GNSS shadow region where a GNSS satellite signal is not received, the client program may obtain positional information from the broadcasted Wi-Fi signal. The client program may correspond to a navigation program, firmware, a map program, a position service program, or so on. The client program may be installed during production of the client device 140 or installed by being downloaded from a cloud server during use of the client device 140.

In operation S620, the client device 140 may register the vehicle license plate information. The client device 140 may receive and store the vehicle license plate information from a user.

In operation S622, the client device 140 may generate a despreading code based on the vehicle license plate information. The client program of the client device 140 may hash the vehicle license plate information using a hash function, convert the hashed value into an orthogonal code, and define the orthogonal code as a despreading code.

When receiving a broadcasted signal from the wireless output device 130, the client device 140 may decode the received composite signal using a despreading code in operation S624. The client device 140 may use the broadcasted signal using a UDP. The client program may operate a CDMA decoder to decode the composite signal using a despreading code.

In operation S626, the client device 140 may obtain positional information when the decoded signal obtained by using the despreading code has a valid value. The client device 140 may output the obtained positional information through the client program, or use the obtained positional information for the client program.

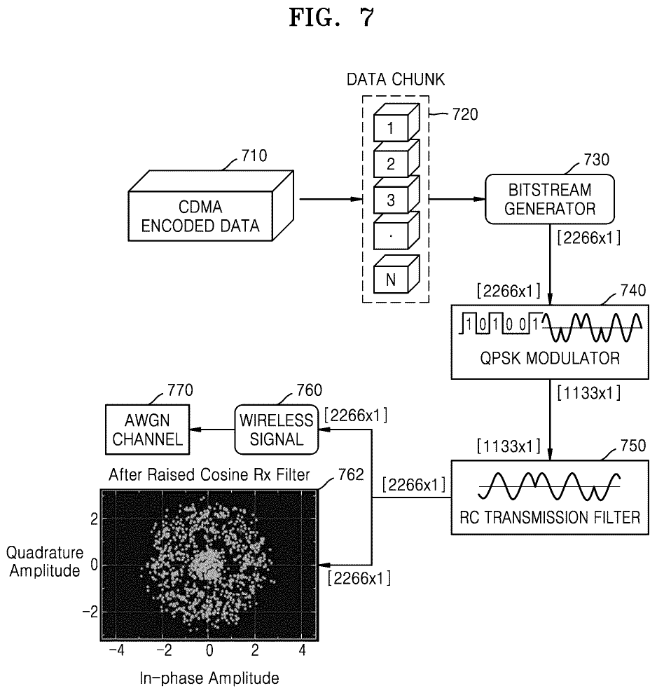

FIG. 7 illustrates a process of generating and transmitting a wireless signal, according to an embodiment. FIG. 7 illustrates a process of generating a wireless signal using QPSK modulation, according to an embodiment.

According to an embodiment, the indoor positioning system 100 (see FIG. 1 or 2) may convert CDMA encoded data 710 generated by the CDMA encoder 510 (see FIG. 5) into a preset number of data chunks 720. The indoor positioning system 100 may generate a plurality of data chunks 720 by dividing data into another data of a preset size.

Next, a bitstream generator 730 of the indoor positioning system 100 may generate a bitstream from the plurality of data chunks 720. The bitstream generator 730 may generate a bitstream for each frame from the plurality of data chunks 720. For example, the bitstream for each frame may have a size of 2266*1.

Next, a QPSK modulator 740 may perform QPSK modulation on the bitstream. The QPSK modulator 740 may generate QPSK symbols in units of bitstream of a size of 1133*1. Therefore, two QPSK symbols may be generated from a single bitstream.

Next, a raised cosine (RC) transmission filter 750 may up-sample the QPSK symbols by two. The RC transmit filter 750 may use a rolloff factor of ½. The RC transmission filter may convert two QPSK symbols into a wireless signal 760 having a magnitude of 2266*1 and output the wireless signal 760. The wireless signal 760 may be represented as a graph 762 including, for example, an in-phase amplitude and a quadrature amplitude.

The wireless signal 760 may be output to an additive white Gaussian noise (AWGN) channel 770. The AWGN channel 770 may be referred to as an additive white Gaussian noise channel. The AWGN channel 770 is a channel in which white Gaussian noise affects characteristics of a signal and may be modeled as a stationary random processor. The AWGN channel may have a frequency offset and variable time delay.

The bitstream generator 730, the QPSK modulator 740, and the RC transmission filter 750 may be included in either the server 120 or the wireless output device 130, or may be included separately in the server 120 or the wireless output device 130.

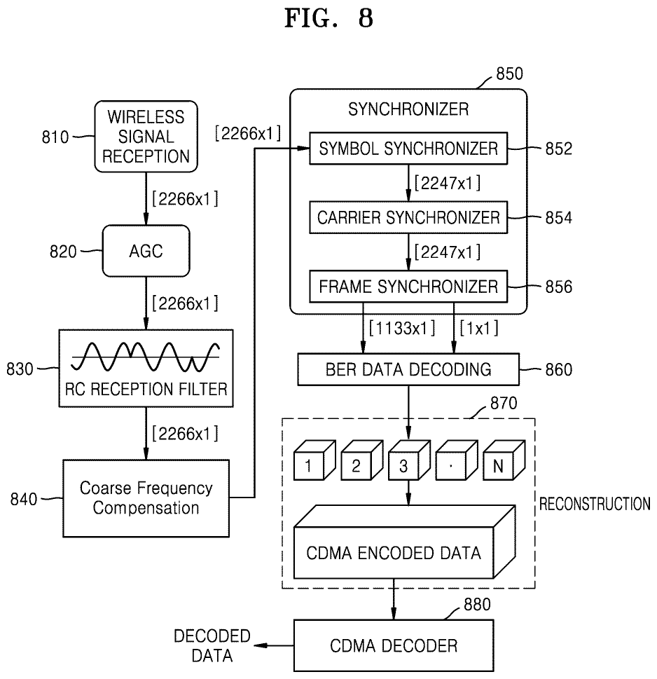

FIG. 8 is a diagram illustrating a process of receiving and decoding a wireless signal by a client device, according to an embodiment. FIG. 8 illustrates a process of converting a QPSK-modulated wireless signal.

According to an embodiment, the client device 140 (see FIG. 1 or 4) may receive a broadcasted wireless signal from the wireless output device 130 (see FIG. 1 or 4) and decode the wireless signal.

The client device 140 may receive the wireless signal in operation 810. The client device 130 may receive the wireless signal through Wi-Fi or a mobile communication network, such as fourth generation (4G)/fifth generation (5G). The wireless signal may include a QPSK symbol having a size of 2266*1.

Next, the client device 140 may perform automatic gain control in operation 820. The client device 140 may apply a gain to the wireless signal received in operation 820 to maintain a wireless signal's amplitude at a constant level. The automatically gain-controlled signal may have a size of 2266*1. The client device 140 may ensure that a phase and timing error detector has a constant gain over time through automatic gain control.

Next, an RC reception filter 830 of the client device 140 may filter a received signal which is automatically gain-controlled. For example, the RC reception filter 830 may use a rolloff index having a value of 0.5. A signal output from the RC reception filter may have a magnitude of 2266*1.

Next, the client device 140 may perform coarse frequency compensation processing in operation 840. The client device 140 may estimate and compensate for an approximate frequency offset of the received wireless signal through the coarse frequency compensation processing.

Next, a synchronizer 850 of the client device 140 may synchronize a wireless signal and convert the wireless signal into frame units. The synchronizer 850 may include a symbol synchronizer 852, a carrier synchronizer 854, and a frame synchronizer 856. The symbol synchronizer 852 may resample an input signal based on a recovered timing strobe to determine a symbol at optimal sampling instants. The carrier synchronizer 854 may compensate for a residual frequency offset and a phase offset. The frame synchronizer 856 may align frame boundaries in a known frame header.

The client device 140 may decode a signal in units of frame which is output from the synchronizer 850 in operation 860. The client device 140 may decode a signal to have a reference bit error ratio (BER) value in operation 860. The client device 140 may resolve phase uncertainty caused by the carrier synchronizer 854, demodulate the signal, and decode an original message.

Next, the client device 140 may reconstruct the CDMA encoded data in operation 870. The client device 140 divides the decoded data into data chunks. Also, the client device 140 generates CDMA encoded data from the data chunks.

Next, a CDMA decoder (880) of the client device 140 may generate decoded data by decoding the CDMA encoded data. The CDMA decoder 880 may decode the data using a despreading code generated based on vehicle license plate information.

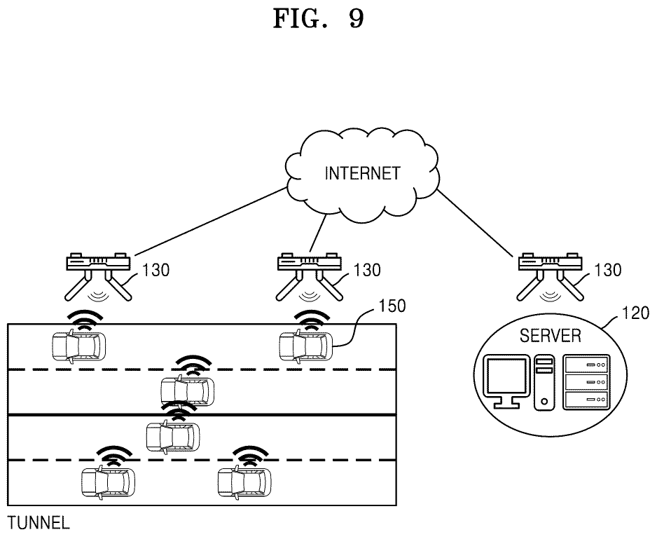

FIG. 9 illustrates a process of outputting wireless signals from a plurality of wireless output devices, according to an embodiment.

According to an embodiment, a server 120 may broadcast wireless signals through a plurality of wireless output devices 130. The server 120 may be connected to the plurality of wireless output devices 130 through the Internet. The server 120 may transmit signals to be output as wireless signals through the Internet to the plurality of wireless output devices 130.

The plurality of wireless output devices 130 may be respectively installed at a plurality of positions inside ae tunnel. The plurality of wireless output devices 130 may each be fixedly installed on a structure, such as a ceiling or wall of the tunnel. The plurality of wireless output devices 130 may be arranged at preset intervals, for example, at intervals of 0.5 km to 2 km. The plurality of wireless output devices 130 may each correspond to a Wi-Fi communication device.

The plurality of wireless output devices 130 may each broadcast a Wi-Fi signal. According to an embodiment, the plurality of wireless output devices 130 may output identical wireless signals. Also, the plurality of wireless output devices 130 may each output a wireless signal through a mobile communication network. When using a 4G communication network, the plurality of wireless output devices 130 may be arranged at certain intervals (for example, at intervals of approximately 1.6 km) based on a communication reference station. When using a 5G communication network, the plurality of wireless output devices 130 may be arranged at certain intervals (for example, at intervals of approximately 500 m) based on a communication reference station.

The client device 140 included in the vehicle 150 moving in a tunnel may receive a broadcasted Wi-Fi signal. The client device 140 may extract information, such as a position, a speed, and a movement direction of the vehicle 150 by extracting symbols from a Wi-Fi signal and performing CDMA decoding on the symbols.

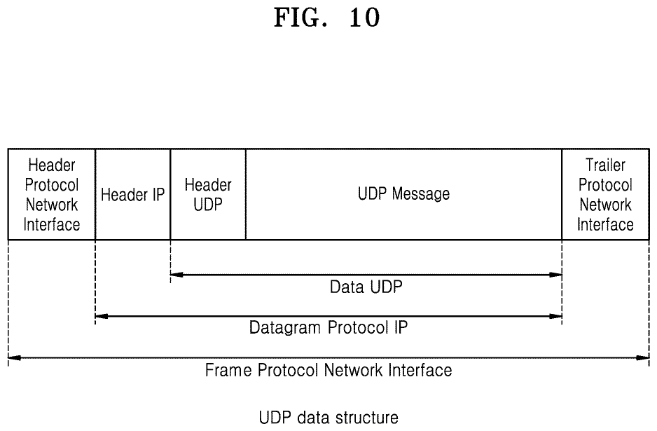

FIG. 10 is a diagram illustrating a data structure of a wireless signal, according to an embodiment.

According to an embodiment, the wireless signal may have a UDP data structure. The UDP data structure is a TCP/IP layer protocol that may transmit data or messages through an IP-based network (for example, the Internet or an intranet) in an unpredictable manner without any initial agreement between a transmitter and a receiver. The UDP data structure may be transmitted as a datagram without sequence numbers or acknowledgement messages. Messages lost during transmission has to be recovered by an application layer protocol which operates on top of an UDP.

The application layer protocol, which operates on top of an UDP, may provide its own dependability service or transmit messages on a regular or preset schedule.

As illustrated in FIG. 10, a single frame protocol network interface of the UDP data structure may include a header protocol network interface, a header IP, a header UDP, a UDP message, and a trailer protocol network interface. The header IP, the header UDP, and the UDP message may constitute a datagram protocol IP. The header UDP and the UDP message may constitute a data UDP. The CDMA encoded data may be included in the UDP message.

In addition, the disclosed embodiments may be implemented in the form of a computer-readable recording medium storing computer-executable instructions and data. The instructions may be stored in the form of program code, and when executed by a processor, the instructions may generate a preset program module to perform a preset operation. Also, when executed by a processor, the instructions may perform preset operations of the disclosed embodiments.

A device-readable storage medium may be provided in the form of a non-transitory storage medium. Here, the term “non-transitory storage medium” simply means a tangible device that does not include a signal (for example, an electromagnetic wave), and this term does not distinguish between a case where data is permanently stored in the storage medium and a case where data is temporarily stored. For example, the “non-transitory storage medium” may include a buffer in which data is temporarily stored.

According to an embodiment, methods according to various embodiments described herein may be included in a computer program product. The computer program product may be traded as a commodity between a seller and a buyer. The computer program product may be distributed in the form of a device-readable storage medium (for example, a compact disc read-only memory (CD-ROM)) or distributed (for example, downloaded or uploaded) online through an application store or directly between two user devices (for example, smartphones). In the case of online distribution, at least part of the computer program product (for example, a downloadable app) may be temporarily stored or temporarily generated in a device-readable storage medium, such as a manufacturer's server, an application store server, or a memory of a relay server.

Embodiments are described above with reference to the attached drawings. Those skilled in the art to which the disclosure belongs will understand that the disclosure may be practiced in forms other than the disclosed embodiments without altering the technical idea or essential characteristics of the disclosure. The disclosed embodiments are illustrative and should not be construed as limiting.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An indoor positioning system comprising:
a camera;
a position detection sensor;
a first communication module;
a memory storing at least one instruction; and
at least one processor configured to execute the at least one instruction to:
generate, based on a position detection signal of the position detection sensor, positional information by recognizing a position of a vehicle moving on a road,
recognize vehicle license plate information and the position of the vehicle moving on the road based on an input image captured by the camera,
encode the positional information in a code-division multiple access (CDMA) method using a spreading code generated from the vehicle license plate information, and
output the encoded positional information as a wireless signal through the first communication module.

2. The indoor positioning system of claim 1, further comprising:
a plurality of detection devices arranged at different positions in an indoor space;
a server configured to communicate with the plurality of detection devices; and
a wireless output device positioned within the indoor space and configured to communicate with the server,
wherein each of the plurality of detection devices includes the camera, the position detection sensor, and a second communication module communicating with the server,
wherein the server includes the memory and the at least one processor and further includes a third communication module configured to communicate with the plurality of detection devices and the wireless output device, and
wherein the wireless output device includes the first communication module communicating with the server and outputting the wireless signal.

3. The indoor positioning system of claim 2, wherein the plurality of detection devices are each configured to generate the positional information based on the position detection signal, generate the vehicle license plate information based on the input image, and transmit the positional information and the vehicle license plate information to the server through the second communication module.

4. The indoor positioning system of claim 2, wherein the server is further configured to receive the vehicle license plate information and the positional information from each of the plurality of detection devices through the third communication module, encode the positional information in the CDMA method using the spreading code generated from the vehicle license plate information, and transmit an encoded code signal to the wireless output device.

5. The indoor positioning system of claim 2, wherein the wireless output device is configured to broadcast the wireless signal through the first communication module.

6. The indoor positioning system of claim 1, wherein:
the position detection sensor includes one of a radio detection and ranging (RADAR) sensor and a light detection and ranging (LIDAR) sensor, and
the at least one processor is further configured to generate speed information of a vehicle of which position is recognized based on the position detection signal by executing the at least one instruction, and output the speed information as the wireless signal.

7. The indoor positioning system of claim 1, wherein the at least one processor is further configured to match the positional information generated from the position detection signal to the vehicle license plate information based on the positional information generated from the position detection signal and the position of the vehicle recognized from the input image, and encode the positional information in the CDMA method using the spreading code generated from the matched vehicle license plate information.

8. The indoor positioning system of claim 1, wherein the at least one processor is further configured to generate code signals, which are encoded in the CDMA method, for pieces of positional information of a plurality of vehicles, generate a composite signal by adding the code signals for the pieces of positional information of the plurality of vehicles, and output the composite signal as the wireless signal.

9. The indoor positioning system of claim 8, wherein the composite signal is configured to be received by a client device arranged inside the vehicle and is decoded using a despreading code generated from the vehicle license plate information stored in the client device.

10. The indoor positioning system of claim 1, wherein the at least one processor is further configured to hash the vehicle license plate information, convert the hashed vehicle license plate information into orthogonal codes that are orthogonal to each other, and encode the positional information in the CDMA method using the orthogonal codes as spreading codes.

11. The indoor positioning system of claim 1, wherein, in outputting the encoded positional information as the wireless signal, the at least one processor further configured to:
convert the encoded positional information into a plurality of data chunks;
generate a bitstream for each frame from the plurality of data chunks;
convert the bitstream for each frame into a quadrature phase shift keying (QPSK) symbol;
up-sample the QPSK symbol using a raised cosine (RC) transmission filter; and
output the up-sampled QPSK symbol as the wireless signal through an additive white Gaussian noise (AWGN) channel.

12. A method of controlling an indoor positioning system, the method comprising:
generating, based on a position detection signal of the position detection sensor, positional information by recognizing a position of a vehicle moving on a road;
recognizing vehicle license plate information and the position of the vehicle moving on the road based on an input image captured by a camera;
encoding the positional information in a code-division multiple access (CDMA) method using a spreading code generated from the vehicle license plate information; and
outputting the encoded positional information as a wireless signal.
